(19) United States
(12) Patent Application Publication
(10) Pub. No.: US 2020/0189335 A1
(43) Pub. Date: Jun. 18, 2020

(54) Method And System For Magnetic Platooning Of Autonomous Electric Vehicles

(71) Applicant: MagnaDrive Corporation, Woodinville, WA (US)

(72) Inventors: Geoffrey R. Harmon, Sammamish, WA (US); Zhongwei Ma, Bellevue, WA (US); Yuan Lian, Fremont, CA (US)

(21) Appl. No.: 16/717,959

(22) Filed: Dec. 17, 2019

Related U.S. Application Data
(60) Provisional application No. 62/780,850, filed on Dec. 17, 2018.
(60) Provisional application No. 62/926,483, filed on Oct. 26, 2019.

(51) Int. Cl. B60D 1/01; G05D 1/00; G05D 1/02; B60L 50/50; B60L 53/18

(52) U.S. Cl. CPC B60D 1/01; G05D 1/0088; G05D 1/0293; B60D 1/246; B60L 53/18; G05D 2201/0213; B60L 50/50

(57) ABSTRACT

Method and system for magnetic platooning of vehicles is disclosed. In one embodiment, a vehicle includes a battery and a vehicle coupler that includes a magnet carrier block having at least one power terminal and at least one magnet. The at least one power terminal is supplied by the battery and the magnet carrier block is configurable in one of two modes. In a first mode, the at least one magnet is disabled from magnetically coupling to a second vehicle coupler. In a second mode, the at least one magnet is enabled to magnetically couple to the second vehicle coupler.

### CROSS-REFERENCE TO RELATED APPLICATIONS

This application claims the benefit under 35 U.S.C. § 119 of U.S. Provisional Application No. 62/780,850, entitled “Magnetic Power Coupling”, filed Dec. 17, 2018. This application also claims the benefit under 35 U.S.C. § 119 of U.S. Provisional Application No. 62/926,483, entitled “Method And System For Magnetic Platooning Of Autonomous Electric Vehicles”, filed Oct. 27, 2019. The subject matter of each of the foregoing documents is expressly incorporated herein by reference.

### TECHNICAL FIELD

The present invention relates generally to magnetic platooning, and more specifically, to magnetic platooning of autonomous electric vehicles.

### BACKGROUND INFORMATION

As the number and variety of vehicles on the roadways continues to increase, techniques to increase efficiency to reduce traffic congestion have become increasingly important. The advent of autonomous vehicles may be making traffic congestion worse, since even non-drivers may be utilizing the roadways in autonomous vehicles.

One potential solution that has been identified to reduce traffic congestion is called vehicle platooning. Instead of cars driving as individual units on highways, a group of autonomous vehicles wirelessly exchange information to enable the group to coordinate their movements. The vehicles in the group communicate their operation to closely follow each other on the roadway. A group of vehicles operating this way can reduce their overall footprint, which means more capacity is available on roads resulting in more efficient travel for all vehicles.

### SUMMARY

In various embodiments, a vehicle coupler system is provided that allows for platooning of electric autonomous vehicles.

In one embodiment, a vehicle includes a battery and a vehicle coupler that includes a magnet carrier block having a power terminal and a magnet. The power terminal is supplied by the battery and the magnet carrier block is configurable in one of two modes. In a first mode, the magnet carrier block is configured so that the magnet is disabled from magnetically coupling to a second vehicle coupler. In a second mode, the magnet carrier block is configured so that the magnet is enabled to magnetically couple to the second vehicle coupler.

The foregoing is a summary and thus contains, by necessity, simplifications, generalizations and omissions of detail; consequently it is appreciated that the summary is illustrative only. Still other methods, and structures and details are set forth in the detailed description below. This summary does not purport to define the invention. The invention is defined by the claims.

### BRIEF DESCRIPTION OF THE DRAWINGS

The accompanying drawings, where like numerals indicate like components, illustrate embodiments of the invention.

FIG. 1 illustrates vehicle platooning using an embodiment of a vehicle coupler.

FIG. 2 shows a cross-section view of the vehicle coupler shown in FIG. 1.

FIG. 3 shows the vehicle coupler and illustrates the position of a magnet carrier block in the uncoupled position (first mode).

FIG. 4 shows the vehicle coupler and illustrates the position of the magnet carrier block in the coupled position (second mode).

FIGS. 5-6 illustrate an example of two vehicle couplers interacting with each other to physically couple together to enable platooning.

FIG. 7 illustrates two vehicle couplers in the first mode and magnetically uncoupled from each other.

FIG. 8 illustrates two vehicle couplers in the second mode and magnetically coupled to each other.

FIG. 9 shows an embodiment of a controller for use with a vehicle coupler.

FIG. 10 illustrates two vehicles coupled together with data and power transfer enabled.

FIG. 11 shows an embodiment of a method for constructing a vehicle coupler.

FIG. 12 shows an embodiment of a method for coupling two vehicles together using vehicle couplers.

### DETAILED DESCRIPTION

A vehicle coupler that is capable of physically and electrically connecting vehicles to enable vehicle platooning. Each vehicle coupler can be scaled to fit different sized vehicles and even power stations. The vehicle coupler can be enabled to couple to another vehicle coupler, or disabled to uncouple from another vehicle coupler. The vehicle coupler utilizes strong magnets to couple to another vehicle coupler so that no mechanical connection (e.g., tow bar or chain) is required.

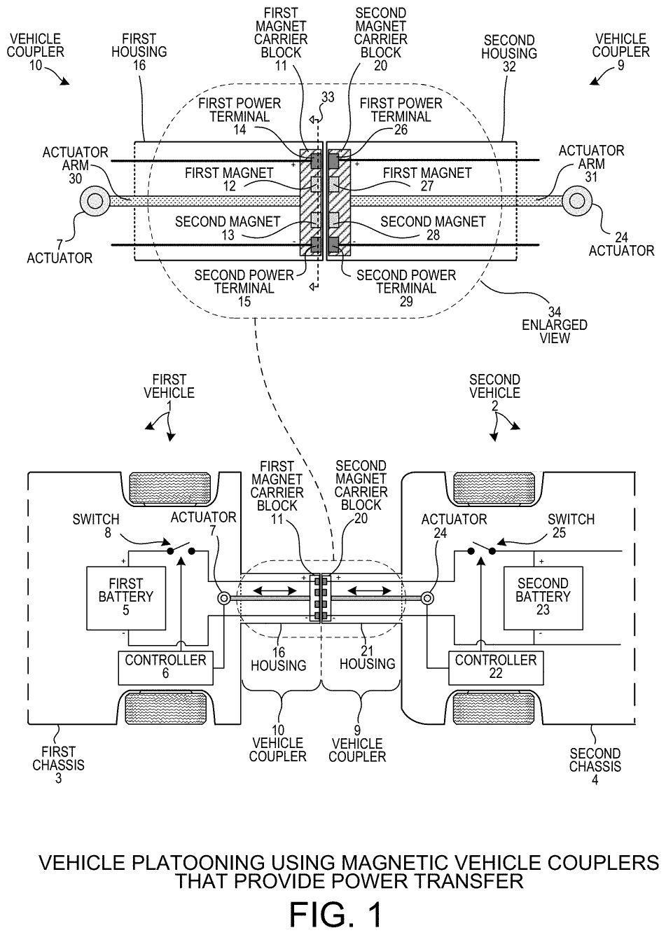

FIG. 1 illustrates vehicle platooning using an embodiment of a vehicle coupler. As illustrated in FIG. 1, a first vehicle 1 comprises a first chassis 3, a battery 5, a controller 6, a switch 8, and an actuator 7. The first vehicle 1 also includes a vehicle coupler 10 having a housing 16 and magnet carrier block 11. The actuator 7 is coupled to the magnet carrier block 11 to move the block back and forth within the housing 16. In an embodiment, the housing 16 is made from polycarbonate or other suitable material.

A second vehicle 2 comprises a second chassis 4, a battery 23, a controller 22, a switch 25, and an actuator 24. The second vehicle 2 also includes a vehicle coupler 9 having a housing 21 and magnet carrier block 20. The actuator 24 is coupled to the magnet carrier block 20 to move the block back and forth within the housing 21.

Each of the magnet carrier blocks 11, 20 comprises magnets that are used to achieve a magnet coupling. For example, when the magnet carrier block 11 is moved to the edge of the housing 16 and the magnet carrier block 20 is moved to the edge of the housing 21, the magnetic fields of the magnets form a magnetic coupling that holds the two blocks together. The strength of the coupling is strong enough so that the first vehicle 1 is able to pull the second vehicle 2 without breaking the magnetic coupling.

Referring now to the enlarged view 34, the first magnet carrier block 11 includes magnets 12 and 13. The second magnet carrier block 20 includes magnets 27 and 28. Magnet 12 is the opposite polarity of magnet 27 and magnet 13 is the opposite polarity of magnet 28. Strong magnetic forces pull the magnets together to form a magnetic coupling. Also shown in the enlarged view 34 is cross-section indicator 33.

In an embodiment, the polarity of the magnets is configured so that the carrier blocks couple together in a particular self-aligning orientation. This self-aligning operation facilitates the connection of electrical terminals. For example, the magnet carrier block 11 includes power terminals 14 and 15. The magnet carrier block 20 includes power terminals 26 and 29. When the carrier blocks are magnetically coupled together, the power terminals also electrically couple. The self-aligning function provides that the connection of the power terminals be pre-configured. Terminal 14 connects to terminal 27, and terminal 15 connects to terminal 29. Any number of terminals may be used and the electrical connections can be used to pass power or data through the magnetically coupled carrier blocks.

To uncouple the carrier blocks, the actuator 7 moves the actuator arm 30 to pull the carrier block 11 away from the end of the housing 16. Similarly, the actuator 24 moves the actuator arm 31 to pull the carrier block 20 away from the end of the housing 32. Thus, the carrier blocks are pulled apart until the magnetic coupling is broken. A more detailed description of the vehicle coupler and its operation to provide vehicle platooning is provided below.

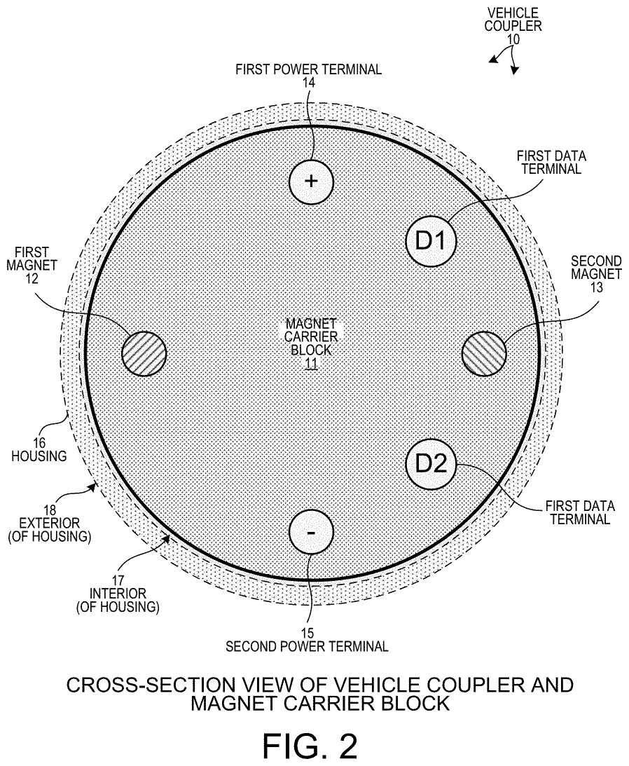

FIG. 2 shows a cross-section view of the vehicle coupler 10 shown in FIG. 1. For example, the cross-section view is taken at cross-section indicator 33. The vehicle coupler 10 physically and electrically connects to another vehicle coupler mounted on a second vehicle. No mechanical connections are required. The vehicle coupler 10 utilizes strong magnets to couple to another vehicle coupler thereby reducing the need to use mechanical parts that would need replacement and become worn-out over time due to mechanical fatigue.

As illustrated in FIG. 2, the vehicle coupler 10 includes the magnet carrier block 11 that includes a first magnet 12, a second magnet 13, a first power terminal 14, and a second power terminal 15. In another embodiment, the magnet carrier block 11 includes at least one magnet and at least one power terminal. In another embodiment, the magnet carrier block 11 includes data terminals (D1, D2) that are used to connected data lines between two vehicles.

The magnet carrier block 11 comprises a circular disc made from any suitable material that is strong enough to withstand the magnetic coupling/uncoupling and towing functions performed by the vehicle coupler 10. For example, the magnet carrier block 11 can be made from composite material, plastic, aluminum, or any other suitably strong material. In an embodiment, the magnet carrier block 11 includes a steel backing or an additional magnetic plate affixed to its rear surface. The steel backing or magnetic plate increases the magnetic field strength of the vehicle coupler 10.

The first magnet 12 and the second magnet 13 comprise strong permanent magnets (e.g., Neodymium) that are designed to fit into holes in the magnet carrier block 11. In one example, rare earth, Neodymium-Iron-Boron magnets are employed, such as an N-42 magnet. FIG. 2 shows the first magnet 12 secured towards the left end of the magnet carrier block 11 and the second magnet 13 secured towards the right end of the magnet carrier block 11. In an embodiment, the first magnet 12 and the second magnet 13 are secured using a strong adhesive such that they do not become displaced when they couple/uncoupled to/from magnets mounted in other vehicle couplers. The first power terminal 14 and the second the second power terminal 15 are designed to fit into holes in magnet carrier block 11. For example, FIG. 2 shows the first power terminal 14 (positive) secured towards the top end of the magnet carrier block 11 and the second power terminal 15 (negative) secured towards the bottom end of the magnet carrier block 11.

In an embodiment, the front surfaces of the magnets and power terminals are on the same plane as the front surface of the magnet carrier block 11 to provide a smooth surface that mates to a magnet carrier block of another vehicle coupler. Additionally, disposing the first magnet 12, the second magnet 13, the first power terminal 14, and the second power terminal 15 along the front surface of the magnet carrier block 11 allows for a better physical connection between magnets and power terminals of two vehicle couplers. Additionally, two magnet carrier blocks that have two magnets located in corresponding positions aligns their power terminals to connect when the two magnet carrier blocks are magnetically connected.

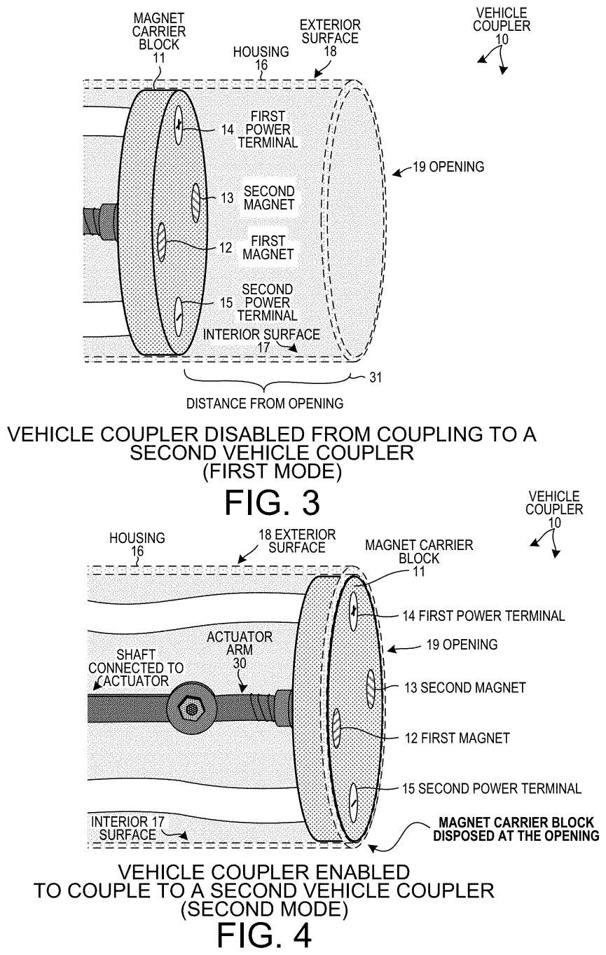

FIG. 3 shows the vehicle coupler 10 and illustrates the position of the magnet carrier block 11 in the uncoupled position (first mode). In an embodiment, the housing 16 is a hollow tube made of a non-magnetic material (e.g., plastic) that includes an interior surface 17, an exterior surface 18, and an opening 19. The shape of the housing 16 is designed to allow the magnet carrier block 11 to slide within the housing 16 along the interior surface 17. For example, the magnet carrier block 11 shown in FIG. 3 is a circular disc that has a diameter that is slightly smaller than the inner diameter of the housing 16. When the magnet carrier block 11 is moved a predetermined distance 31 from the opening 19, the vehicle coupler 10 will not couple due to the reduce magnetic field strength that appears at the opening 19. For example, in the first mode, the magnetic fields generated by the first magnet 12, and the second magnet 13 are diminished at the opening 19 because the magnets 12-13 are located at a horizontal distance 31 from the opening 19 of the housing 16.

In another example, a vehicle coupler 10 has a non-circular shaped housing and the magnet carrier block is shaped to slide along the interior surface of the non-circular shaped housing.

FIG. 4 shows the vehicle coupler 10 and illustrates the position of the magnet carrier block 11 in the coupled position (second mode). For example, in the second mode, the vehicle coupler 10 is enabled to couple to a vehicle coupler of another vehicle. In this second mode, the magnet carrier block 11 is moved by the actuator so that it is disposed at the opening 19. In this position, vehicle coupler 10 is enabled to connect to a vehicle coupler of another vehicle.

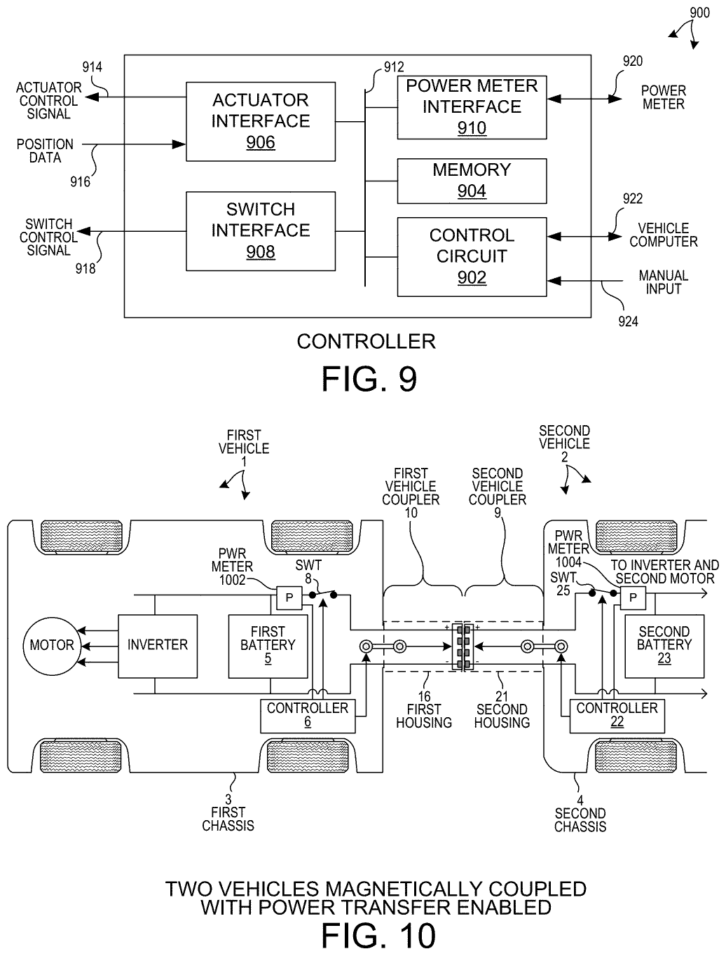

To move the magnet carrier block 11, an actuator (not shown) drives the actuator arm 30 to cause the magnet carrier block 11 to slide along the interior surface 17 until it reaches the opening 19. In one example, the magnet carrier block 11 is connected to the actuator via a shaft. In another example, the magnet carrier block 11 is attached to a retractable connector. As explained in more detail with respect to FIG. 9, the actuator is controlled by control signaling generated by a controller. In one embodiment, the length of the shaft that connects the magnet carrier block 11 to the actuator is shorter than the length of the housing 16. This prevents the magnet carrier block 11 from extending or being dislodged outside of the housing 16.

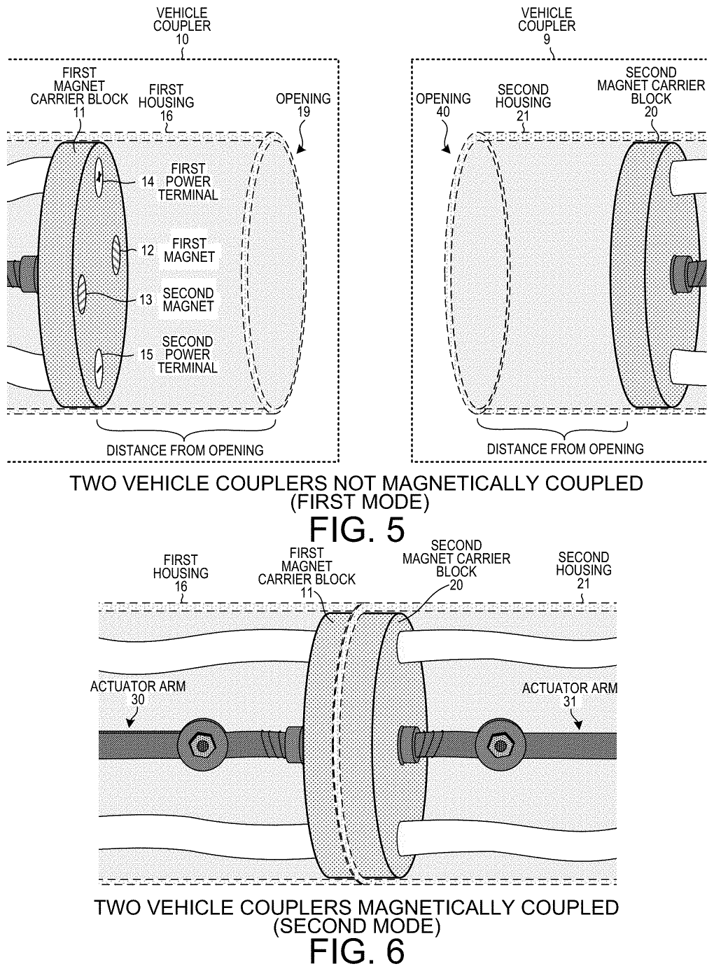

FIGS. 5-6 illustrate an example of how two vehicle couplers interact with each other to physically couple together to enable platooning.

FIG. 5 illustrates two vehicle couplers in the first mode and not magnetically coupled to each other. In the example shown in FIG. 5, a first vehicle coupler 10 includes a first magnet carrier block 11, a first magnet 12, a second magnet 13, a first power terminal 14, and a second power terminal 15 disposed within a first housing 16 having an opening 19. A second vehicle coupler 9 includes a second magnet carrier block 20 disposed within a second housing 21 having an opening 40. Although not shown in FIG. 5, the second magnet carrier block 20 includes a third magnet, a fourth magnet, a third power terminal, and a fourth power terminal.

The second magnet carrier block 20 is similar to the first magnet carrier block 11, but is rotated 180 degrees so that opposite magnets and terminals are aligned when the magnet carrier blocks 11 and 20 are coupled together in the second mode. Thus, the power terminals of each magnet carrier block should be configured so that when the magnet carrier blocks are coupled together the mating power terminals having the same polarity.

FIG. 6 illustrates two vehicle couplers in the second mode and magnetically coupled to each other. When magnetically connected, the first magnet carrier block 11 and the second magnet carrier block 20 are touching each other as are the magnets and power terminals associated with each carrier block. For example, as illustrated in FIG. 1, the first magnet 12 is aligned with the third magnet 27, and the second magnet 13 is aligned with the fourth magnet 28. Similarly, the first power terminal 14 is aligned with the third power terminal 26, and the second power terminal 15 is aligned with the fourth power terminal 29. The alignment of the magnets and power terminals in the second mode means that the vehicle couplers are magnetically coupled and electrically connected. The first vehicle can then pull the second vehicle and power sharing between the vehicles can be performed.

One method of transitioning from the first mode to the second mode is by the use of two actuators. For example, the first magnet carrier block 11 is driven by actuator arm 30, which moves the magnet carrier block 11 closer to the opening 19. Similarly, the second magnet carrier block 20 is driven by actuator arm 31, which moves the magnet carrier block 20 closer to the opening 40. Once the magnet carrier blocks 11 and 20 are disposed near their respective openings 19 and 40, the magnetic fields from the magnets pull the carrier blocks together in a specific orientation, such that the power terminals are coupled together. To transition from the second mode to the first mode, each actuator arm is controlled to pull each of the magnet carrier blocks 11 and 20 away from their respective opening, thereby uncoupling the carrier blocks.

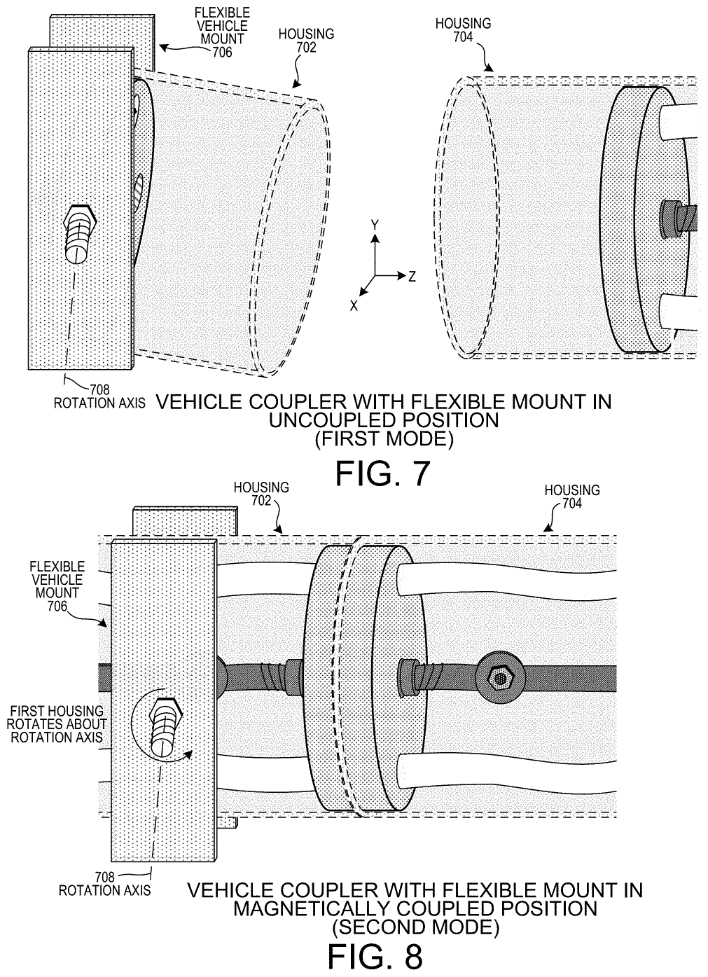

FIG. 7 illustrates a vehicle coupler mounted to a vehicle using a flexible vehicle mount 706. As illustrated in FIG. 7, housing 702 of a first coupler is attached to a vehicle using the flexible vehicle mount 706. In this embodiment, the flexible vehicle mount 706 allows the housing to move in the “Y” direction based on an axis of rotation 708. It should be noted that other mounting types can be utilized to allow the housing 702 to move freely in the X, Y, and Z directions. A second housing 704 of a second vehicle coupler is shown. Both vehicle couplers are in the uncoupled state (e.g., mode 1).

FIG. 8 illustrates the vehicle couplers shown in FIG. 7 in the second mode and magnetically coupled to each other. For example, the magnetic carrier blocks of each coupler have been moved to the mode 2 position. As the couplers are moved closer together, the flexible mount 706 allows the housing 702 to move in the Y direction to couple with the second vehicle coupler. By using the flexible mount 706, the vehicle couplers can move freely in the X, Y, and Z directions to magnetically couple to another vehicle. The flexible mount 706 reduces the need for perfect alignment of the vehicles before coupling.

FIG. 9 shows an embodiment of a controller 900 for use with a vehicle coupler. For example, the controller 900 is suitable for use as the controller 6 or the controller 22 shown in FIG. 1. In an embodiment, the controller 900 comprises a control circuit 902, memory 904, actuator interface 906, switch interface 908, and power meter interface 910 all coupled to communicate over a data bus 912.

The control circuit 902 comprises at least one of a processor, CPU, gate array, programmable logic, memory, logic, and discrete circuits. The control circuit 902 controls the operations of the other functional blocks of the controller 900. The control circuit 902 uses a communication channel 922 to communicate with a vehicle computer to exchange information and instructions. For example, the control circuit 902 receives instructions from the vehicle computer that indicate how a magnet control block is to be moved during a coupling operation. The control circuit 902 also sends information to the vehicle computer, such as power readings received by the power meter interface 910. The control circuit 902 also receives manual inputs 924 that can be used to directly control a vehicle coupler using the actuator interface 906.

The memory 904 comprises RAM, ROM, programmable memory and/or any other suitable memory to store information associated with the controller 900.

The actuator interface 906 comprises any suitable hardware or firmware to interface with an actuator, such as actuator 7 shown in FIG. 1. The actuator interface 906 outputs actuator control signals 914 to control the movement of an actuator. The actuator interface 902 receives position data 916 that indicates the current position of an actuator, so that the location of a magnet carrier block can be determined.

The switch interface 908 comprises any suitable hardware or firmware to interface with a switch, such as switch 8 shown in FIG. 1. The switch interface 908 outputs switch control signals 916 to control the movement of a switch to open or close. The control circuit 902 can control the state of switches in a vehicle coupler using the switch interface 908.

The power meter interface 910 comprises any suitable hardware or firmware to interface with a power meter, such as power meter 1002 shown in FIG. 10. The power meter 1002 takes power measurements indicating the direction and amount of power associated with the battery 5. The power meter 1002 sends the power measurements to the power meter interface 910 for processing by the control circuit 902. For example, the control circuit 902 sends the power measurements to the vehicle computer using the communication channel 922.

It should be noted that the functions and circuits of the controller 900 are exemplary and that other functions and circuits may be utilized.

FIG. 10 illustrates two vehicles magnetically coupled together with data and power transfer enabled. For example, the first vehicle coupler 10 is magnetically coupled to the second vehicle coupler 9. Thus, the magnets and power terminals of the vehicle couplers are magnetically and electrically connected, respectively. In this illustration, the switches 8 and 25 are in the closed position, which allows power to flow between the vehicles. For example, power from the battery 5 can flow through the switches 8 and 25 to charge the battery 23. If the second vehicle 2 is further coupled to a third vehicle, the power from the battery 5 can flow to the third vehicle in a similar manner. Thus, it is possible to transfer power in either direction when vehicles are magnetically coupled using the connected power terminals of the vehicle couplers.

In another embodiment, power meters 1002, 1004 are included that measure power flowing between the vehicles. This measured power can be used to determine overall battery life or to establish a financial payment for power that is sent or received between vehicles. In another embodiment, a bandwidth monitor is included that measures and monitors data transfer flowing between vehicles. The measured data is used to establish financial payment for data that is sent or received between vehicles.

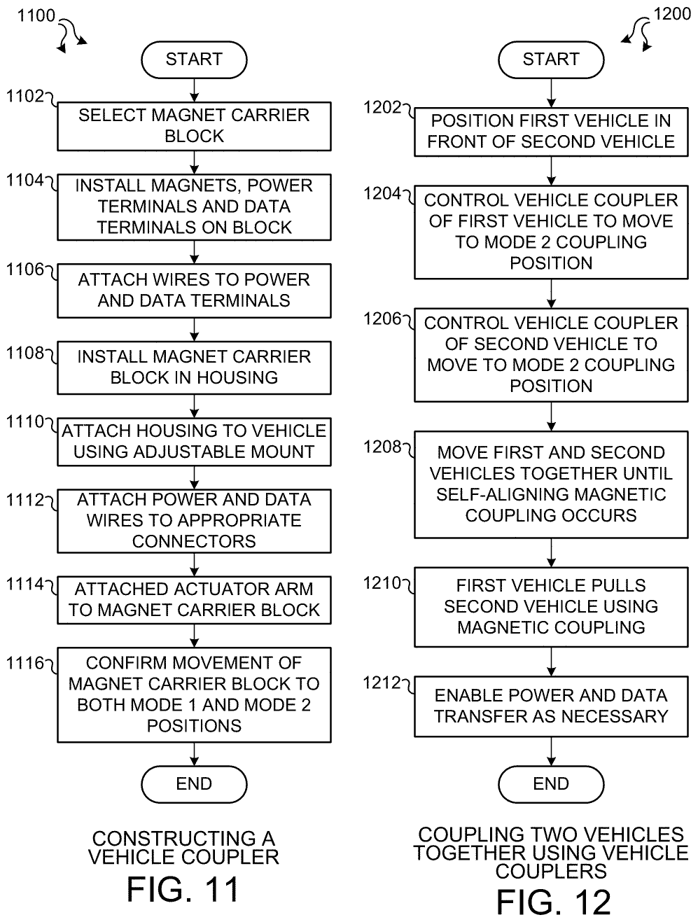

FIG. 11 shows an embodiment of a method 1100 for constructing a vehicle coupler. For example, the method 1100 is suitable for use to construct vehicle couplers as illustrated in FIGS. 1-8.

At block 1102, a magnet carrier block is selected. For example, the magnet carrier block may be cylindrical or have any other suitable shape.

At block 1104, magnets, power terminals, and data terminals are installed on the magnet carrier block. For example, there may be two magnet terminals, two power terminals and any number of data terminals.

At block 1106, wires are attached to the power and data terminals.

At block 1108, the magnet carrier block is installed in a housing.

At block 1110, the housing is mounted to a vehicle using an adjustable mount that allow the housing to move in all directions.

At block 1112, the power and data wires are appropriate connectors of the vehicle.

At block 1114, the movement of the magnet carrier block to the mode 1 and mode 2 positions is confirmed.

It should be noted that the operations of the method 1100 are exemplary and changes or modifications may be made with the scope of the embodiments.

FIG. 12 shows an embodiment of a method for coupling two vehicles together using vehicle couplers. For example, the method 1200 is suitable for use with vehicle couplers as illustrated in FIGS. 1-8.

At block 1202, a first vehicle is positioned in front of a second vehicle. Each vehicle includes a vehicle coupler as described herein.

At block 1204, the vehicle coupler of the first vehicle is controlled to move to the mode 2 position for coupling.

At block 1206, the vehicle coupler of the second vehicle is controlled to move to the mode 2 position for coupling.

At block 1208, the first and second vehicles are moved closer together until a self-aligning magnetic coupling occurs.

At block 1210, the first vehicle pulls the second vehicle using the magnetic coupling.

At block 1212, power and data transfer between the vehicles is enabled as necessary.

It should be noted that the operations of the method 1200 are exemplary and changes or modifications may be made with the scope of the embodiments.

Although certain specific embodiments are described above in order to illustrate the invention, the invention is not limited to the specific embodiments. It is understood that in various embodiments, magnets of the system may be magnetically coupled together but not in direct contact with each other, or magnets may be magnetically coupled together and in direct contact with each other. In one embodiment, a magnet of one vehicle coupler is coupled to another magnet of another vehicle coupler and does not physically contact the other magnet. In another embodiment, a magnet of one vehicle coupler is coupled to another magnet of another vehicle coupler and physically contacts the other magnet. Accordingly, various modifications, adaptations, and combinations of various features of the described embodiments can be practiced without departing from the scope of the invention as set forth in the claims.

1. A vehicle comprising:
a battery; and
a vehicle coupler that includes a magnet carrier block having at least one power terminal and at least one magnet, wherein the at least one power terminal is supplied by the battery, wherein the magnet carrier is configurable in one of two modes, wherein in a first mode, the at least one magnet is disabled from magnetically coupling to another vehicle coupler, and wherein in a second mode, the at least one magnet is enabled to magnetically couple to another vehicle coupler.

2. The vehicle of claim 1, further comprising:
a housing, wherein the housing has an interior, an exterior, and an opening, wherein the magnet carrier block is disposed within the interior of the housing, wherein in the first mode, the magnet carrier block is disposed a distance away from the opening of the housing, and wherein in the second mode, the magnet carrier block is disposed at the opening of the housing.

3. The vehicle of claim 1, wherein the magnet carrier block has a first magnet and a second magnet, wherein the first magnet is opposite the second magnet, and wherein the first magnet and the second magnet are configurable in the second mode to magnetically couple to external magnets disposed on another vehicle coupler.

4. The vehicle of claim 1, wherein the at least one power terminal comprises a first power terminal and a second power terminal, wherein the first power terminal is opposite the second power terminal, and wherein the first power terminal and the second power terminal are configurable in the second mode to supply an external battery connection disposed on another vehicle coupler.

5. The vehicle of claim 1, wherein the magnet carrier block has at least one data communication terminal, and wherein the data communication terminal is configured to communicate a data signal from the vehicle to another vehicle.

6. The vehicle of claim 1, further comprising:
a controller, wherein the controller controls whether the magnet carrier block is in the first mode or in the second mode.

7. A system comprising:
a first vehicle having a first battery and a first magnet carrier block, wherein the first magnet carrier block has a first power terminal and a first magnet, wherein the first power terminal is supplied by the first battery, and wherein the first magnet carrier block is configurable in one of two modes; and
a second vehicle having a second battery and a second magnet carrier block, wherein the second magnet carrier block has a second power terminal and a second magnet, wherein the second power terminal is supplied by the second battery, wherein the second magnet carrier block is configurable in one of two modes, wherein in the first mode, the second magnet carrier block is disabled from magnetically coupling to the first magnet carrier block of the first vehicle, and wherein in the second mode, the second magnet carrier block is enabled to magnetically couple to the first magnet carrier block of the first vehicle.

8. The system of claim 7, wherein when both the first magnet carrier block and the second magnet carrier block are in the second mode, and when both the first magnet carrier block and the second magnet carrier block are coupled together, the first magnet is coupled to and contacts the second magnet, and the first power terminal is coupled to and contacts the second power terminal.

9. The system of claim 7, wherein when both the first magnet carrier block and the second magnet carrier block are in the second mode, and when both the first magnet carrier block and the second magnet carrier are coupled together, the first battery is configurable to supply components disposed on the second vehicle via the first power terminal and the second power terminal.

10. The system of claim 9, wherein the component disposed on the second vehicle that is supplied by the first battery is taken from the group comprising of: a power converter, the second battery, a controller, and a motor.

11. The system of claim 7, wherein the system is a vehicle platooning system, wherein the first magnet carrier block, and the second magnet carrier block are substantially similar structures.

12. The system of claim 11, wherein the vehicle platooning system does not involve any wireless communication between the first vehicle and the second vehicle, and wherein the vehicle platooning system does not involve any mechanical communication between the first vehicle and the second vehicle.

13. The system of claim 7, wherein the first vehicle has a first housing, wherein the first magnet carrier block is disposed within an interior of the first housing, wherein the second vehicle has a second housing, and wherein the second magnet carrier block is disposed within an interior of the second housing.

14. The system of claim 13, wherein the first housing is movable with respect to a first chassis of the first vehicle, and wherein the second housing is movable with respect to a second chassis of the second vehicle.

15. The system of claim 7, wherein the first vehicle and the second vehicle are operable to magnetically connect via the first magnet carrier block and the second magnet carrier block while both the first vehicle and the second vehicle are moving, and wherein the first vehicle and the second vehicle are operable to power share via the first magnet carrier block and the second magnet carrier block while both the first vehicle and the second vehicle are moving.

16. A method comprising:
(a) attaching a first magnet carrier block of a first vehicle to a second magnet carrier block of a second vehicle, wherein the first magnet carrier block has a first power terminal and a first magnet, wherein the first power terminal is supplied by a first battery, wherein the second magnet carrier block has a second power terminal and a second magnet, wherein the second power terminal is supplied by a second battery.

17. The method of claim 16, further comprising:
(b) controlling current to flow between the first power terminal and the second power terminal.

18. The method of claim 17, wherein (a) occurs while the first vehicle and the second vehicle are moving.

19. The method of claim 17, further comprising:
(c) detecting an amount of energy transferred from the first battery of the first vehicle, through the first power terminal, and to the second power terminal; and
(d) causing a first entity associated with the first vehicle to receive payment from a second entity associated with the second vehicle, wherein the payment is based on the amount of energy detected in (c).

20. The method of claim 16, further comprising:
(b) controlling data to flow between the first power terminal and the second power terminal;
(c) detecting an amount of data transferred from the first vehicle, through the first power terminal, and to the second power terminal; and
(d) causing a first entity associated with the first vehicle to receive payment from a second entity associated with the second vehicle, wherein the payment is based on the amount of data detected in (c).

21-28. (canceled)
